(19) United States
(12) Patent Application Publication
(10) Pub. No.: US 2016/0341175 A1
(43) Pub. Date: Nov. 24, 2016

(54) COASTAL WAVE ENERGY CONVERTOR (COWEC)

(71) Applicant: Pieter Jan De Geeter, Subiaco (AU)

(72) Inventor: Pieter Jan De Geeter, Subiaco (AU)

(21) Appl. No.: 15/101,593

(22) PCT Filed: Dec. 3, 2014
(86) PCT No.: PCT/IB2014/066557

§ 371 Date: Jun. 3, 2016

(30) Foreign Application Priority Data
Dec. 4, 2013 (AU) 2013905075

(51) Int. Cl. F03B 13/22; H02K 7/18; F03B 13/14

(52) U.S. Cl. CPC F03B 13/22; F03B 13/145; H02K 7/1823

(57) ABSTRACT

An apparatus for conversion of marine wave energy into electrical energy, having a rigid box-type structure with an open front that is configured to be placed virtually upright on the seafloor with the open front being positioned transverse to the propagation direction of the incoming waves. The structure is positionable at a desired water depth that ensures, at mean sea level, that the structure is semi-submerged. The structure defining an internal chamber that is positionable below the crest level of the incoming design wave and that gradually decreasing from the front to a rear wall by at least 25%. The apparatus also has at least one turbine, positioned within the internal chamber proximate the rear wall and below mean sea level, that is configured to convert the wave's energy into electrical energy.

### FIELD OF THE INVENTION

This disclosure relates to an apparatus for conversion of marine wave energy into electrical energy.

### BACKGROUND

The technology for the conversion of marine wave energy into electrical energy is still in its infancy. All systems currently in operation or under development have a low energy conversion rate due to the fact that they are activated by either the vertical, up-and-down, component or by the horizontal, back-and-forth, component of the water particle's orbital motion. This implies that no more than 50% of the wave's total energy can be converted into mechanical or electrical energy.

However, it would be possible to almost double the energy conversion rate by ‘trapping’ the wave's total energy (dynamic plus potential) within a costal wave energy converter (“COWEC”), such as the exemplified rigid box type structure.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a plan view of a wave refraction pattern.

FIG. 2 is side elevational schematic view of a wave profile.

FIG. 3A is an index graph showing the relationship between wave breaker height verses deepwater wave steepness.

FIG. 3B is an index graph showing the relationship between k², H/d and T\sqrt{g}/d.

FIG. 3C is an index graph showing Cnoidal wave surface profiles as a function of k².

FIG. 4 is side elevational schematic view of an arrested wave profile.

FIG. 5A is a schematic top plan view of a COWEC apparatus of the present invention.

FIG. 5B is a schematic side elevational view of the COWAC apparatus of FIG. 5A.

FIG. 5C is a cross-sectional view of the COWAC apparatus, taken across line B-B′ of FIG. 5B.

FIG. 6A is a cross-sectional view of the COWAC apparatus, taken across line C-C′ of FIG. 5B.

FIG. 6B is a cross-sectional view of the COWAC apparatus, taken across line D-D′ of FIG. 5A.

FIG. 7A is a schematic side elevational view of a COWEC apparatus of the present invention, showing an exemplary wave run-up profile.

FIG. 7B is a cross-sectional view of the COWAC apparatus, taken across line E-E′ of FIG. 7A.

FIG. 8A is a schematic side elevational view of a COWEC apparatus showing the COWEC apparatus being anchored to the sea floor.

FIG. 8B is a schematic plan view showing the anchoring of the COWAC apparatus of FIG. 8A.

FIG. 8C is a schematic time plot of heave motions.

FIG. 9 is a schematic view of a water turbine for the COWAC apparatus.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

For clarity, it will be appreciated that this disclosure will focus primarily on the end or cross-sectional views of a locking clamp. As such, it is contemplated that the described cross-section features of the elements forming the locking clamp can also extend the elongate longitudinal length of the respective elements such as, for example and without limitation, the base member, the tongue member and the locking member.

As used throughout, the singular forms “a,” “an” and “the” include plural referents unless the context clearly dictates otherwise. Thus, for example, reference to “a chamber” can include two or more such chambers unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

Referring to the figures, described herein is an apparatus for conversion of marine wave energy into electrical energy. In one aspect, the COWAC apparatus comprises a box 1 that can be configured to.

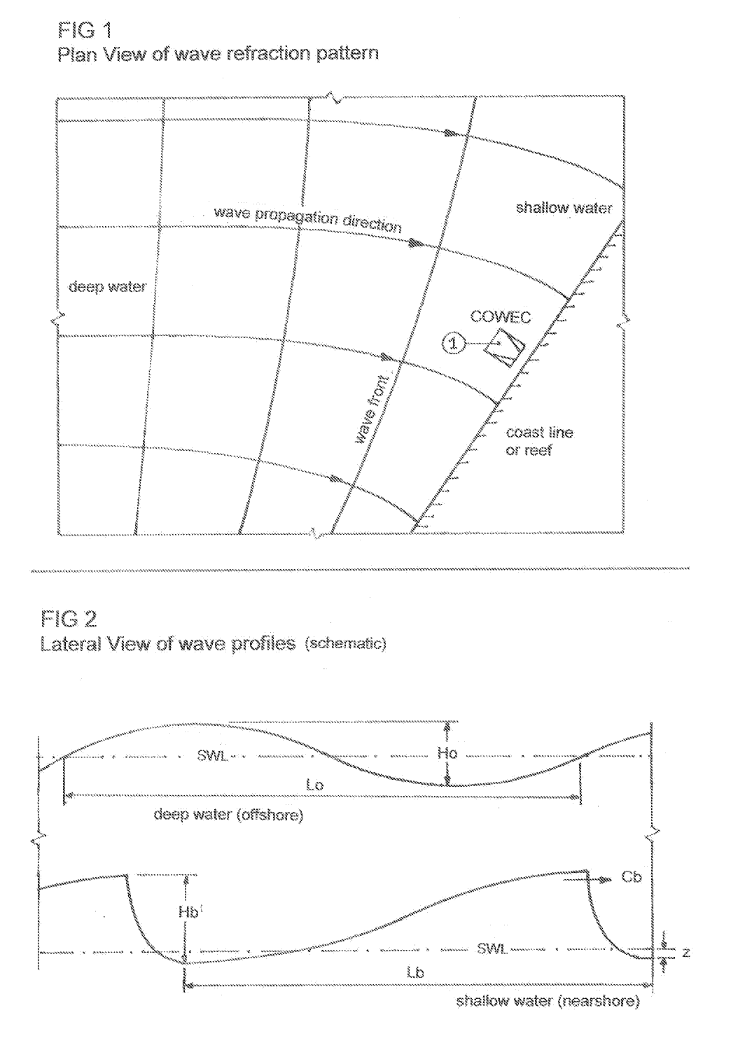

Placed on the seabed close to shore in shallow water with its longitudinal axis aligned with the predominant propagation direction of the incoming waves as indicated by number 1 in FIG. 1.

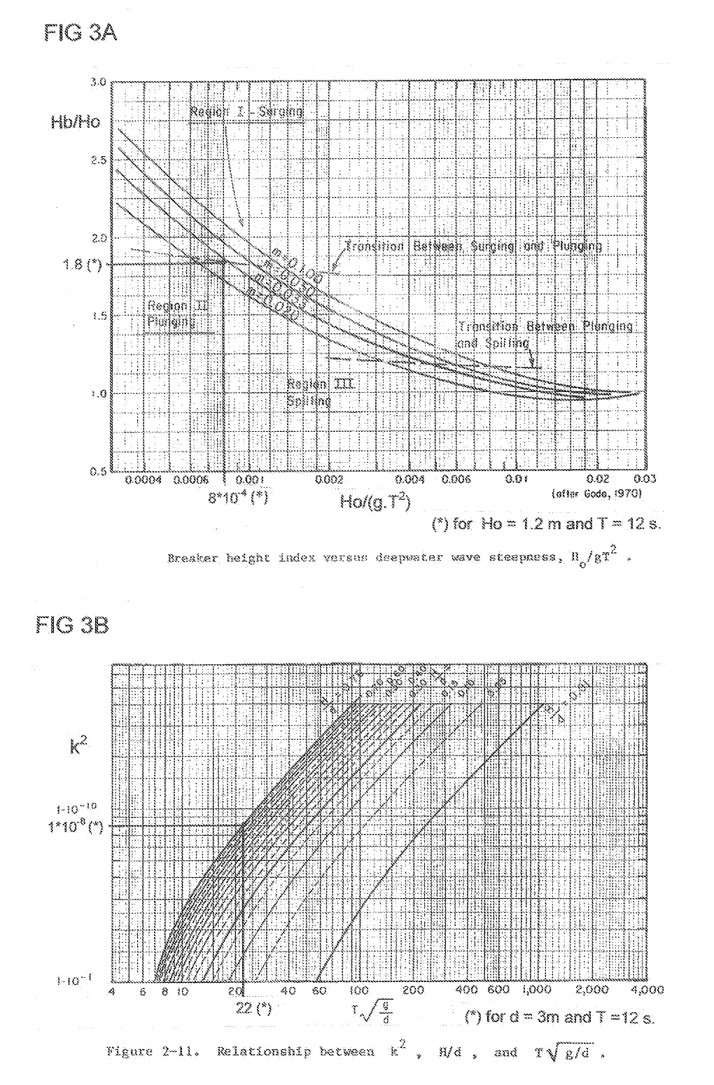

Due to the decrease in water depth and associated increase in bed friction, the incident (deep-water) wave slows down and, as a consequence, its longitudinal profile deforms whilst the height of the wave gradually increases from Ho to Hb (prior to breaking) as indicated in FIG. 2.

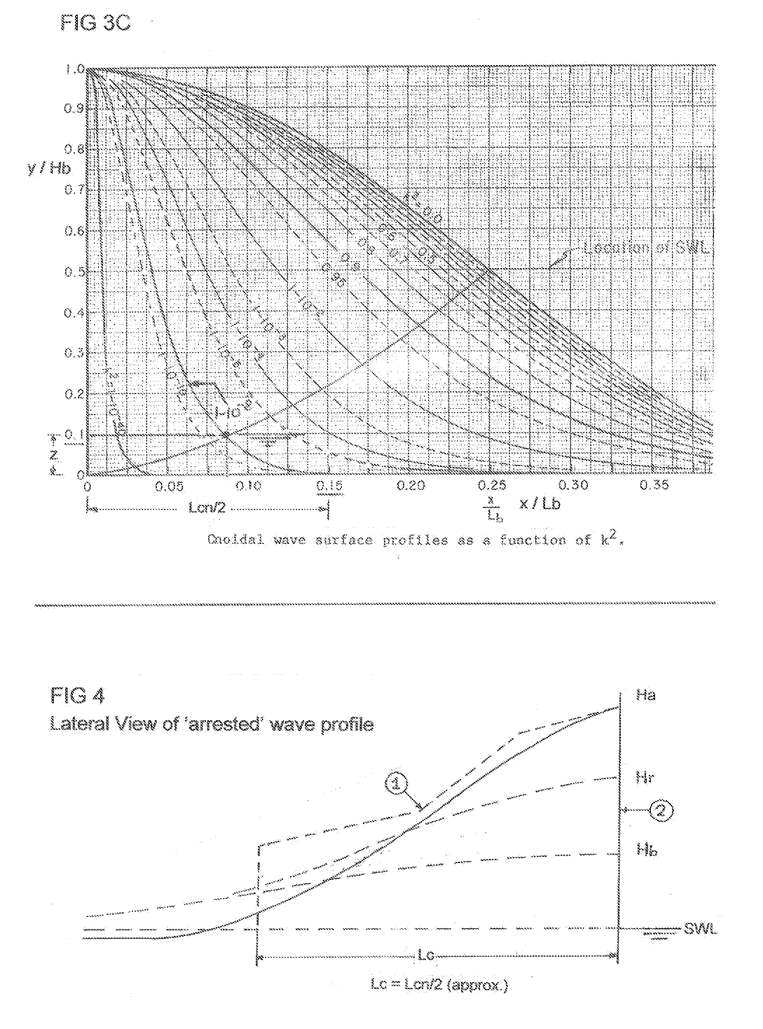

From the average seabed gradient the so-called breaker index (Hb/Ho) can be calculated as indicated in FIG. 3A. This makes it possible to determine the shape of the nearshore (cnoidal) wave profile with sufficient accuracy, with reference to FIGS. 3B and 3C.

Once the wave profile has entered the box 1 its forward momentum is ‘arrested’ at an inner (rear) wall 2 as indicated in FIG. 4. This renders a reflected wave height (Hr) which is approximately twice as high as incoming wave height (Hb). In one aspect it is contemplated that, after installation, the weight of the caisson can be increased by filling flotation chambers 3 and 4 with sand, concrete or another relatively heavy fill material. This could prevent the structure from being shifted by the large horizontal force generated by Hr.

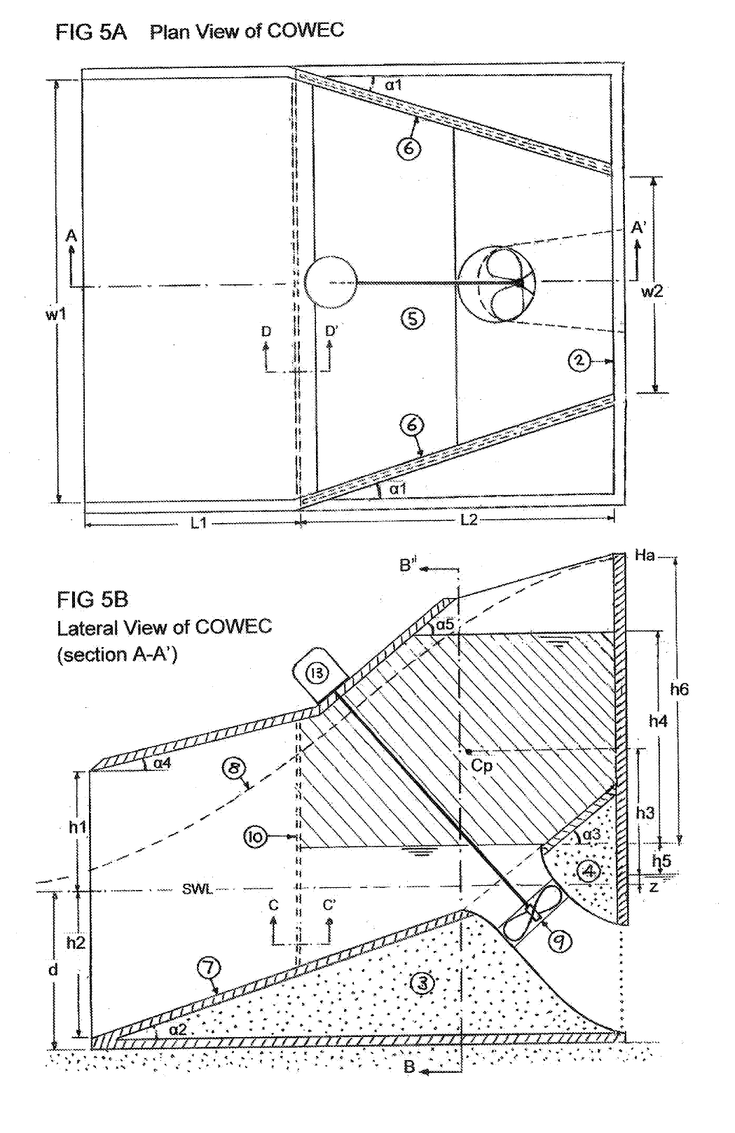

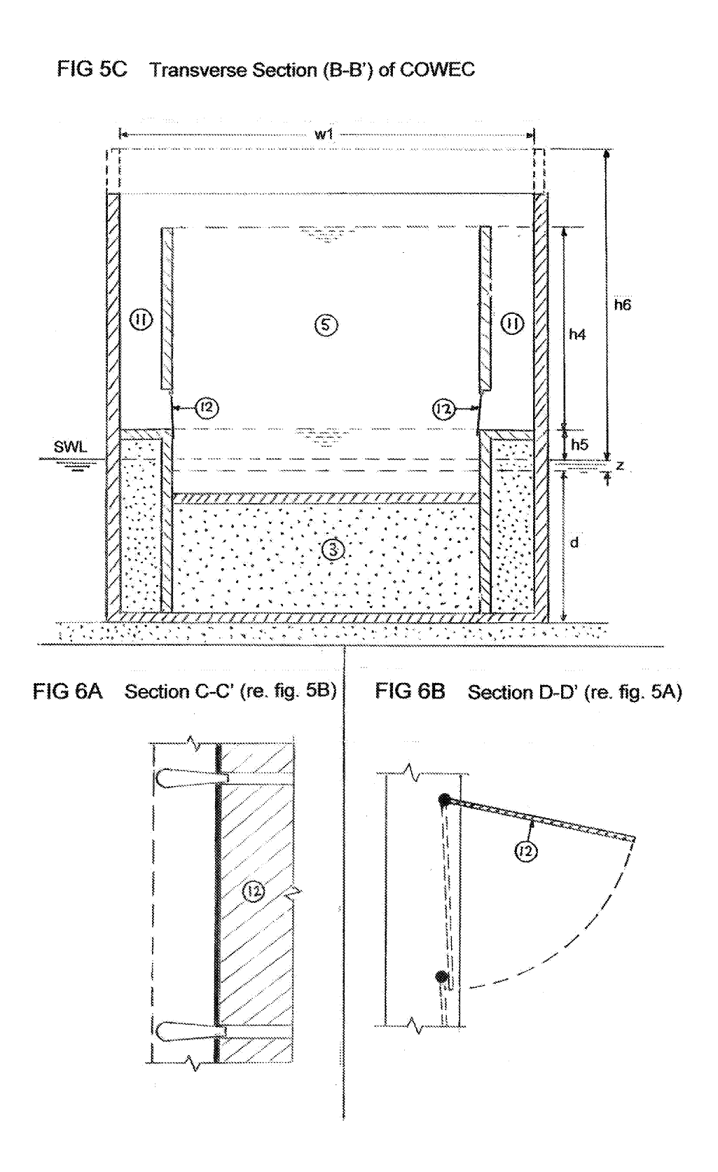

Once “caught” within the caisson, the wave's energy is laterally compressed within central chamber 5 by the ‘squeezing’ effect of side walls 6 shown in FIG. 5A, whilst the water is forced upward by sloping floor 7 as shown in FIG. 5B. It renders a further, substantial, increase in height (Ha) of the arrested wave profile 8. This is significant, given the fact that the efficiency of low-head turbine improves markedly at increased operational head.

After having peaked, the gravitational drop of the wave profile can be limited by the presence of a unidirectional screen 10 (10) which prevents the trapped water mass from flowing back towards the entry point of the caisson.

As a consequence the drop in water level will be restricted, from peak level h6 to level h4 as indicated in FIG. 5B. By the time the next wave enters the box the stored water volume would have discharged via the turbine, during which the internal water level drops to approximately level h5.

As the discharging time is short (slightly less than 12 s.) the diameter of the turbine duct would need to be relatively large. (around 1.8 m).

In a “base load” operation, the incoming wave height (Hb) is slightly lower than the entrance height (h1) of the box. The water volume contained in the wave profile is sufficiently large to fill the box up to static head level h4. From the drained water mass, dropping from level h4 to level h5 over wave period T, the “base” power of the turbine/generator can be calculated.

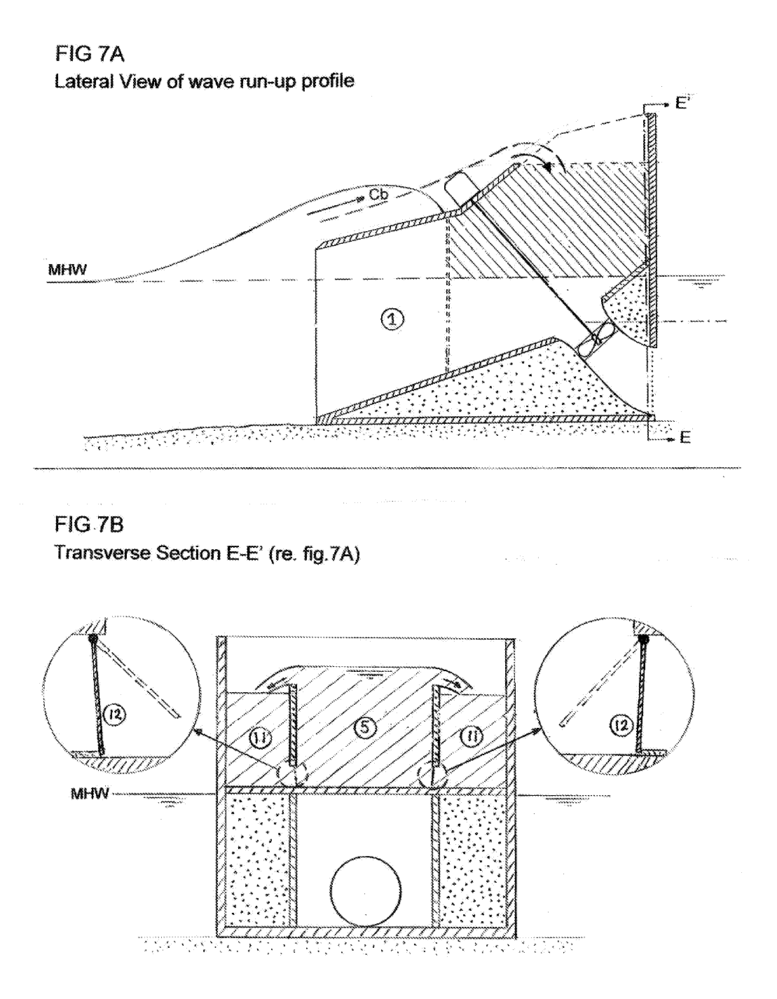

At a rising (tidal) sea level and/or an increased wave height, the top “slice” of the wave runs up the ‘roof’ of the box, spilling into side chambers 11 as indicated in FIGS. 7A and 7B. This significantly increases the total stored water volume and the associated power output of the turbine. During the discharging process the water mass in the side chambers discharges into the central chamber 5 through the opening of rotary gates 12.

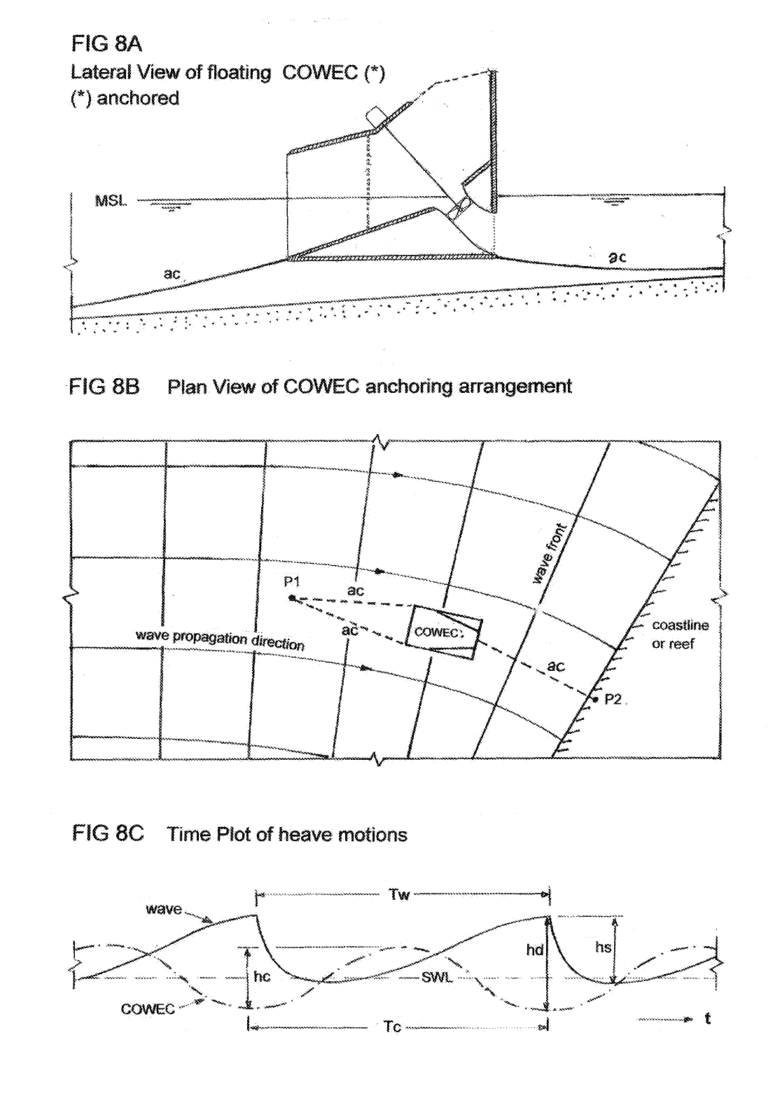

In areas where the tidal water level variations are large, the net storage volume within the box is greatly reduced around the time of high water. As a consequence the power generated by the turbine would drop off accordingly. If these conditions prevail during considerable periods of time it would be preferable to operate the box in flotation mode as indicated in FIGS. 8A and 8B (held in place by anchor chains (ac) and/or by stretchable cables or ropes, secured at anchor points P1 and P2 respectively). As a consequence, the box's draught and the turbine's power output would remain virtually constant, regardless of the level of the tide.

By the right combination of mass and compensating buoyancy, the box would have a natural heave period (Tc) approximately equal to wave period (Tw). This causes so-called resonance, with the caisson's heave period being approximately 180 degrees out of phase with the wave period, as indicated in FIG. 8C. This has the added benefit of increasing the peak operational head of the turbine from static value (hs) to dynamic value (hd), rendering a corresponding increase in power output.

For a deep water wave height (Ho) of 1.2 m, occurring in the world's oceans during more than 90% of time and a mean water depth (d) in front of the box of—say—3 m, breaker index (Hb/Ho) is approximately 1.8 (as shown in FIG. 3A). This renders: Hb=1.8*1.2 m=2.2 m. At a period of 12 s. the wave's celerity (Cb) follows from Cb=(g·d)^{0.5} This renders: Cb=(9.81*3.0)^{0.5}=5.4 m/s.

Wave length (Lb) follows from: Lb=Cb*T=65 m. From the graphs in FIGS. 3B and 3C one finds a cnoidal wave length (lcn) of 0.3*Lb=20 m. This means that, to fully “capture” the arrested wave profile (8) as indicated in FIG. 4 the required structural length (L1+L2) of the box needs to be around 10 m. (about 50% of lcn)

The volume of water (Vw) contained within the cnoidal wave profile (per m. width) amounts to at least 20 m2 (as estimated from the wave's profile as shown in FIG. 3C). This implies that for an entry width (w1) of about 8 m the total water volume (Vw) contained within central chamber (9) is around 160 m3.

Peak height (Ha) of the arrested wave profile follows from the reduction of the box's cross sectional area. In lateral direction the reduction ratio (rh) equals w2/w1 (with ref. to FIG. 5A). For a width reduction of—say—50% this renders: rh=0.50.

In the vertical plane the profile reduction ratio (rv) approximately equals h1/(h1+h2), with reference to FIG. 5B. For h1=Hb=2.2 m and h2 being approximately equal to “d” one finds: rv=2.2/(2.2+3)=0.42.

The increase in wave height (from Hb to Ha) follows from the expression: (Ha/Hb)=(rh*rv)^{-0.5}=(0.50*0.42)^{-0.5}=2.2. Consequently, h6=Hb*2.2=4.8 m.

For a lowest “drained” static head (h5) of about 1 m this renders a peak head (Ha) of 5.8 m, dropping immediately thereafter to level h4. (roughly 1.3 m below Ha).

The total amount of potential energy (Ep) contained in the stored water volume (Vw) follows from the expression Ep= [symbol] .g.Vw.h3 in which [symbol] is the density of seawater (1025 kg/m3) and h3 is the elevation of the water volume's centre of gravity above the ocean surface at the turbine's outflow point. The calculated value of h3 is around 2.5 m. (roughly 50% of h4+h5).

For a stored water volume of 160 m3 one finds: Ep=1025*9.81*160*2.5=4.0*10⁶ Joule. The corresponding wave power (Pw) follows from Pw=Ep/T in which T is the time interval between successive waves. For a realistic value of around 12 s. (on average) this renders: Pw=(4.0/12)*10⁶=330*10³Watt.

At a turbine/generator efficiency (te) of at least 75% this renders a net ‘base load’ power of Pw*te/100, amounting to 330*0.75=250 KW. The generated power would be transferred from generator 13 to an onshore transformer by means of a subsea cable. (not shown).

In one aspect, it can be shown that as soon as the height of the incident wave increases by around 50% to 1.8 m, the overflow mechanism described in FIGS. 7A and 7B would cause side chambers 11 to fill up, increasing the totally stored water volume from 160 m3 to around 220 m3. This generates a proportionate increase in the output of generator 12, from 250 KW to around 350 KW, occurring during at least 50% of total time. At an annual average of around 300 KW, this renders a net energy output of approximately 2.5 Million KWH per year. It is also contemplated that some further gain in output may be accomplished through a physical model testing program in which the dimensions of the caisson and/or the inclination angles (α) of its inner faces would be varied

Implementation would not have any negative effects, environmentally or otherwise. The installed structure would not affect marine life and would not pose any risk to humans. A provisional engineering study has shown that, if—preferably—fabricated in reinforced concrete, the dry weight of the structure would not exceed 300 T. This implies that, in case of multiple production, the all-incost per unit, inclusive of marine towage and subsequent installation, would not exceed USD 1 M. (at 2014 price and cost levels)

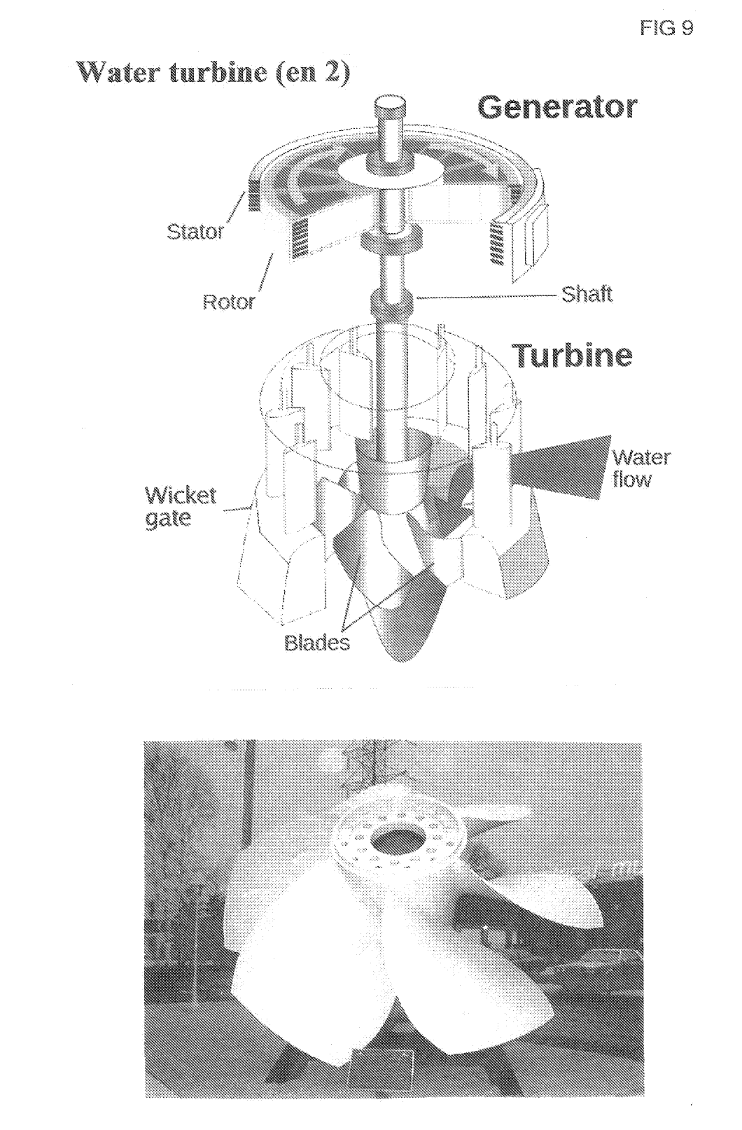

In contrast to all other systems of energy generation (onshore and offshore), the annual cost of management, operation and maintenance of the box/turbine assembly would be minimal. Flotsam and debris in suspension would be kept out of the box by means of a coarse grating at its entry point. (not shown). Small objects, sand or other fine materials in suspension would pass straight through without any negative effect on the operation of the turbine. (which would most probably be a reversely operated Archimedian screw or a proven type of rotor or impellor, as shown in FIG. 9. Further, provisional CAPEX and OPEX analyses have shown that, at current consumer and industry pricing tariffs per KW, the return on investment would be high. (fully recoverable within five years).

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1-4. (canceled)

5. An apparatus for conversion of marine wave energy into electrical energy, comprising:
a rigid box-type structure with an open front that is configured to be placed virtually upright on the seafloor with the open front being positioned transverse to the propagation direction of the incoming waves, wherein the structure is also positioned at a desired water depth that ensures, at mean sea level, that the structure is semi-submerged, wherein the structure has sufficient weight to retain full stability against sliding or tilting under the highest possible wave forces, wherein the structure defines an internal chamber that is positionable below the crest level of the incoming design wave and that gradually decreasing from the front to a rear wall by at least 25%, and wherein the structure further has an internal non-return shutter type screen proximate the front end that is configured to permit unrestricted entry of the water mass of the incoming wave profile whilst preventing any reverse outflow of the water mass enters the open front of the structure; and
at least one turbine, positioned within the internal chamber proximate the rear wall and below mean sea level, wherein the turbine is configured to convert the wave's energy into electrical energy.

6. The apparatus of claim 5, wherein the rigid box-type structure is configured to float in all tidal conditions without contact with the seafloor.

7. The apparatus of claim 6, further comprising a mooring system that is coupled to the structure and the sea floor, wherein the motion of the structure in the horizontal plane constained to desired limits by the mooring system.

8. The apparatus of claim 5, further comprise at least one internal side chamber that is configured to accept additional sea water.

9. The apparatus of claim 5, wherein the mass of the rigid box-type structure creates a vertical oscillation resonance with respect to the sea water wave period.

10. The apparatus of claim 9, wherein the vertical oscillation resonance of the structure is about 180 degrees out of phase with the wave period.
